(19) United States
(12) Patent Application Publication
(10) Pub. No.: US 2026/0122381 A1
(43) Pub. Date: Apr. 30, 2026

(54) ENERGY SAVING: WAVELENGTH DIVISION MULTIPLEXING (WDM) AND PASSIVE OPTICAL NETWORK (PON) LAUNCH OPTICAL CHANNEL ENERGY, POWER AND EFFICIENCY

(71) Applicants: AT&T Intellectual Property I, L.P., Atlanta, GA (US); AT&T Communications Services India Private Limited, Bangalore (IN)

(72) Inventors: Mritunjay Pandey, Bangalore (IN); Lynn Rivera, Naples, FL (US); Subhash Kapoor, Wall, NJ (US)

(73) Assignees: AT&T Intellectual Property I, L.P., Atlanta, GA (US); AT&T Communications Services India Private Limited, Bangalore (IN)

(21) Appl. No.: 18/929,911

(22) Filed: Oct. 29, 2024

(51) Int. Cl. H04Q 11/00; G06F 40/40

(52) U.S. Cl. CPC H04Q 11/0062; G06F 40/40; H04Q 2011/0081; H04Q 2011/0084

(57) ABSTRACT

Aspects of the subject disclosure may include, for example, collecting information about network nodes and network branches in a waveform-division multiplexing-passive optical network (WDM-PON), forming an embedding model based on the information about network nodes and network branches, receiving an input query, providing, by a nearest-neighbor search tool associated with the embedding model, one or more maximum probability responses in response to the input query, providing a query based on the one or more maximum probability responses to a large language model, and receiving, from the large language model, information to improve performance of one or more aspects of the WDM-PON. Other embodiments are disclosed.

### FIELD OF THE DISCLOSURE

The subject disclosure relates to improvement of optical transmitter channel power, energy, and efficiency in a wavelength division multiplexing passive optical network.

### BACKGROUND

A wavelength division multiplexing passive optical network (WDM-PON) is a high-capacity, scalable network technology. Surging popularity of such networks, including the number of end devices, requires an increase in data rate, throughput, and other factors. This may require an increase in WDM-PON transmitter channel power and energy and, at the same time, increases the operational cost of network components.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates factors affecting optical signal strength of a signal transmitted in a fiber of a fiber optic system.

FIG. 2C is a block diagram illustrating an example, non-limiting embodiment of a software defined energy controller (SDEC) functioning within the system of FIG. 2A in accordance with various aspects described herein.

FIG. 2D depicts an illustrative embodiment of a system modeling process in accordance with various aspects described herein.

FIG. 2E depicts an illustrative embodiment of a system for managing optical transmitter channel power, energy, and efficiency in a wavelength division multiplexing passive optical network.

FIG. 2F shows a modelling process in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for optimally configuring or reconfiguring operational aspects of a passive optical network using a topology manager, artificial intelligence and machine learning systems in a software defined energy controller. Other embodiments are described in the subject disclosure.

One or more aspects of the subject disclosure include collecting information about network nodes and network branches in a waveform-division multiplexing-passive optical network (WDM-PON), forming an embedding model based on the information about network nodes and network branches, receiving an input query, providing, by a nearest-neighbor search tool associated with the embedding model, one or more maximum probability responses in response to the input query, providing a query based on the one or more maximum probability responses to a large language model, and receiving, from the large language model, information to improve performance of one or more aspects of the WDM-PON.

One or more aspects of the subject disclosure include providing, to an embedding model, operational requirements information for a possible network scenario for an optical communication network, receiving, from the embedding model, a plurality of recommendations for satisfying the possible network scenario, providing the plurality of recommendations to a large language model, receiving, from the large language model, a response, wherein the response includes information recommending operational features and network devices which are adapted to satisfying the possible network scenario, and modifying the operational features or the network devices, or both, according to the response from the large language model.

One or more aspects of the subject disclosure include receiving network infrastructure information defining structural aspects and functional aspects of a passive optical network (PON), the PON including network nodes and network branches which connect the network nodes, receiving a request to define one or more optimal operational characteristics of the PON, receiving from an embedded model, a plurality of recommendations for network devices, the plurality of recommendations selected to facilitate the one or more optimal operational characteristics of the PON, providing the plurality of recommendations to a retrieval augmented generation (RAG) pipeline including a large language model (LLM), receiving from the RAG pipeline, a recommendation defining the one or more optimal operational characteristics of the PON, and initiating a modification to one or more network devices according to the recommendation.

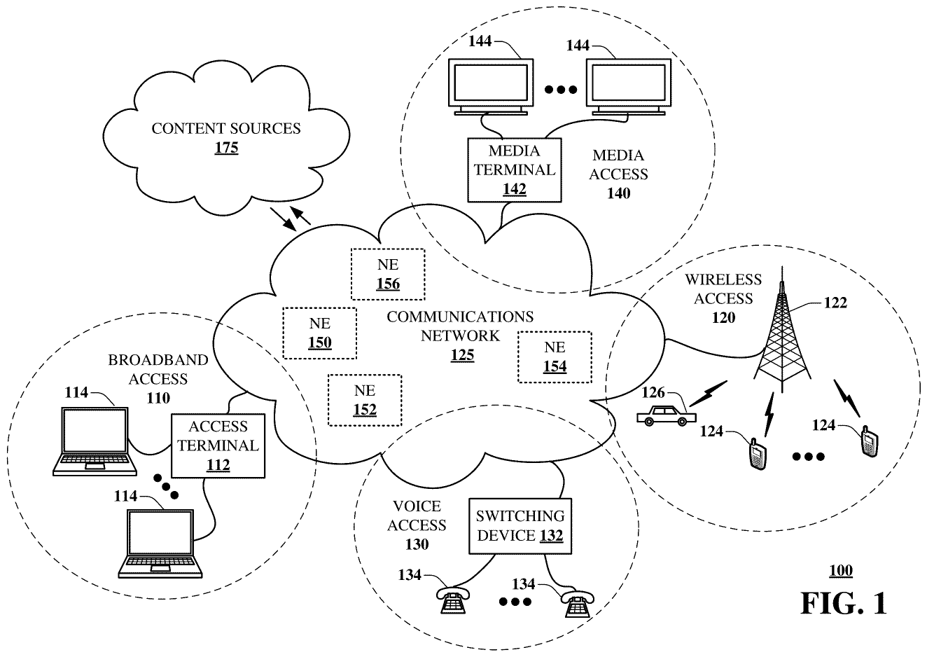

Referring now to FIG. 1, a block diagram is shown illustrating an example, non-limiting embodiment of a system 100 in accordance with various aspects described herein. For example, system 100 can facilitate in whole or in part configuring or reconfiguring an optical communication network that may be a part of the system 100. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

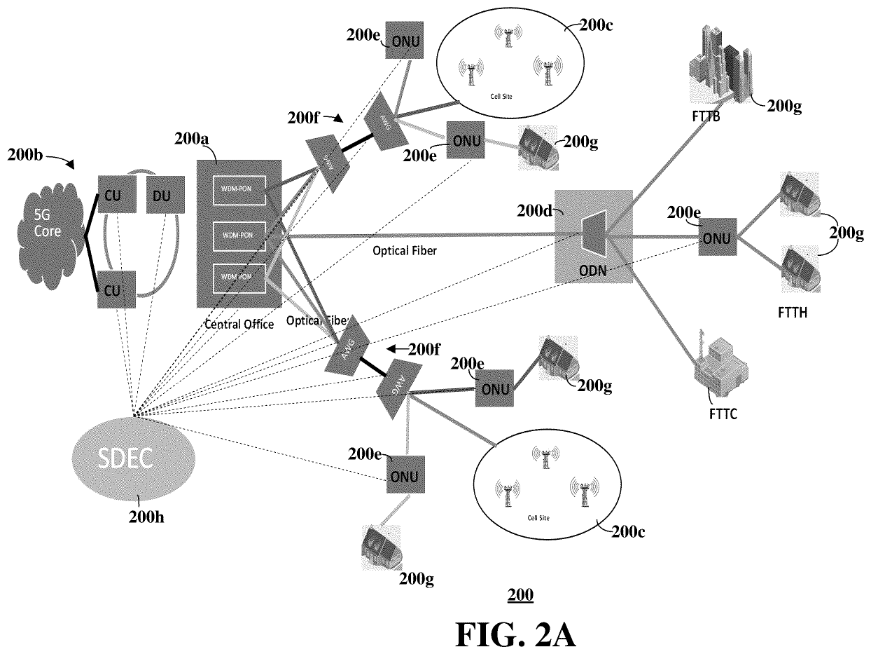

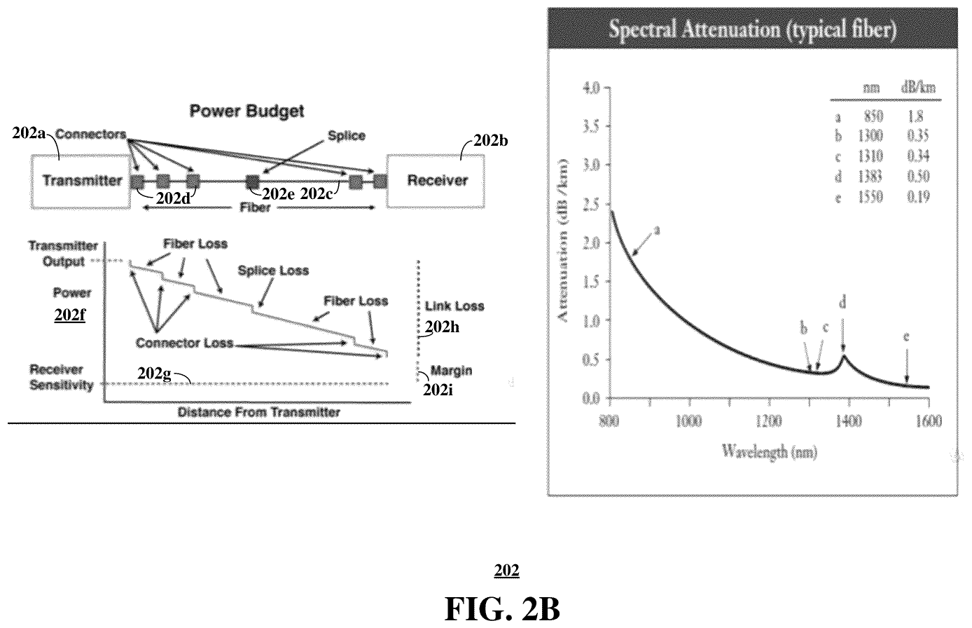

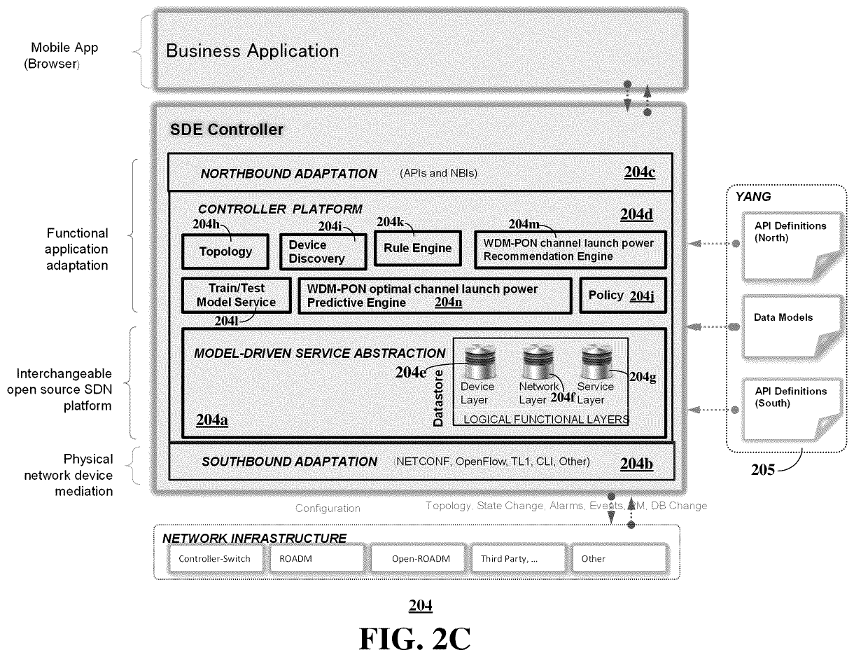

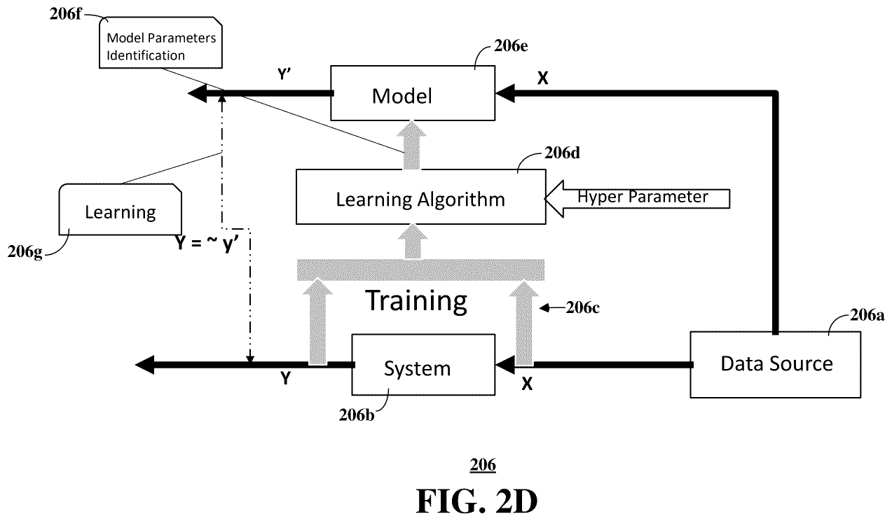

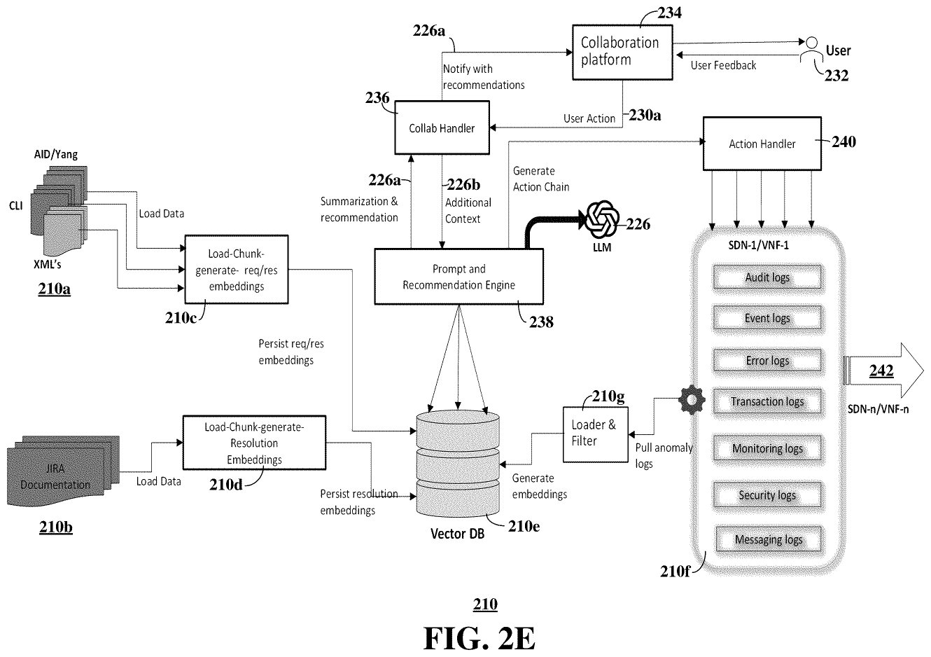

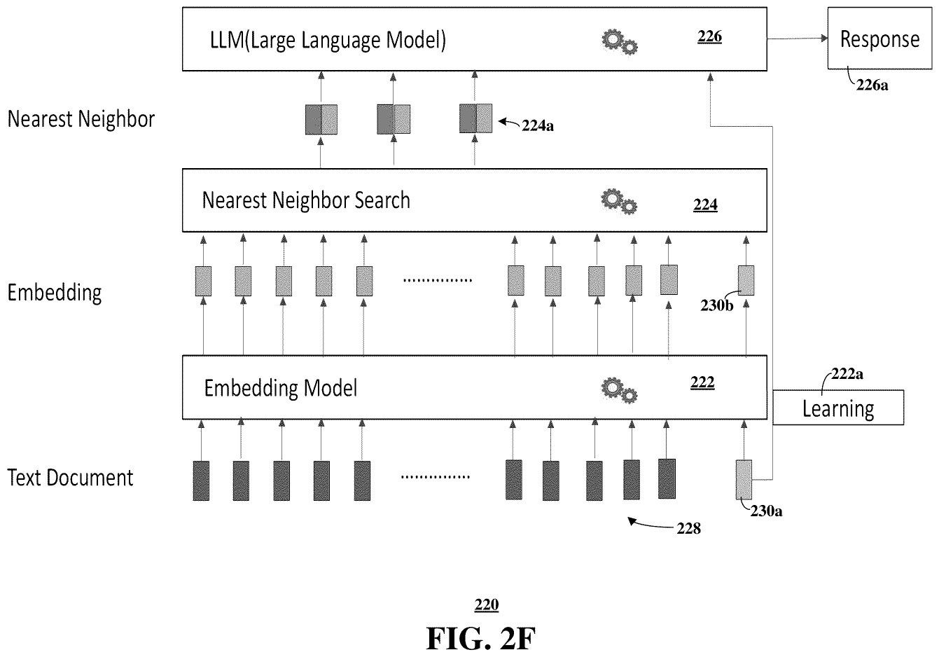

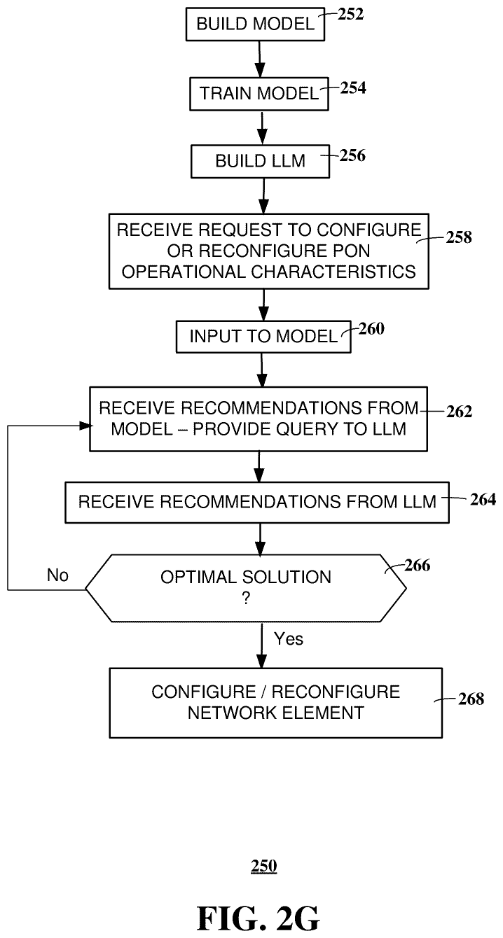

FIG. 2A is a block diagram illustrating an example, non-limiting embodiment of a system 200 functioning within the communications network 125 of FIG. 1 in accordance with various aspects described herein. The system 200 includes a wavelength division multiplexing-passive optical network (WDM-PON) connecting a number of telecommunication components in the system 200. The system 200, and the constituent components and connections, are intended to be exemplary only. Other systems will include other types of components for facilities and other types of interconnections.

The system 200 includes a central office 200a, a fifth generation wireless (5G) core network 200b, a number of cell sites 200c, an optical distribution network (ODN) 200d, a number of optical network units (ONUs) 200e, a number of wireline connections (AWG) 200f and a number of optical connections 200g to customer premises or facilities. Generally, the components are connected via optical fiber forming the WDM-PON. An exception is the AWG 200f which may use copper cable for come interconnections.

The central office 200a collects together in a centralized location many of the communication channels and facilities. The central office 200a enables communication among the various branches of the system as well as to outside elements external to the system 200. In the example, the central office 200a includes multiple WDM-PON networks and devices.

The 5G core network 200b controls wireless communication with user equipment in areas served by the cell sites 200c. The 5G core network 200b is associated with other functional elements such as centralized units (CU) and distributed units (DU) for controlling and routing communications in a cellular network. The 5G core network 200b communicates with the cell sites 200c over optical fibers. These connections may include one or more AWGs 200f.

Optical fiber further connects the central office 200a with the optical distribution network 200d as well as a number of ONUs 200e. The ONUs 200e form a termination point for the optical fiber in the WDM-PON network. The ONUs 200e may convert optical signals on the optical fiber to electrical signals for communication with endpoints at customer premises. In other examples, the ONUs 200e provide an optical connection to the PON network for fiber to the customer premises, which may include fiber to the home (FTTH), fiber to the edge (FTTE), fiber to the premises (FTTP), and fiber to the building (FTTB). Many of these are exemplified in FIG. 2A. The ONUs 200e provide functions such as data transmission, power management, and network management.

Similarly, the ODN 200d serves to distribute optical signals from the central office 200a to the ONUs 200c. The ODN 200d may provide point-to-point communication, in which each subscriber has a dedicated fiber optical connection from an optical line termina (OLT) or a point-to-multipoint communication in which a single optical fiber is shared among multiple subscribers.

The exemplary embodiment of the system 200 further includes a software defined energy controller 200h. The software defined energy controller (SDEC) 200h is a network management tool to optimize energy consumption within the Passive Optical Network (PON) architecture. As suggested by the dashed lines in FIG. 2A, the SDEC 200h is in data communication with many or most components of the system 200. This communication enables collection of data from the components as well as command and control of the components to manage operation and performance of the components of the system 200. The SDEC 200h can dynamically manage and control various aspects of the PON network and system 200 to reduce power consumption while maintaining network performance. For example, the SDEC 200h can allocate power to ONUs 200c based on their traffic load and usage patterns. This can help ensure that ONUs 200e are not consuming more power than necessary. In some embodiments, the SDEC 200h can put idle ONUs 200e into a low-power sleep mode to conserve energy. In embodiments, the SDEC 200h can distribute traffic across multiple ONUs 200e to balance the load and reduce power consumption in heavily utilized ONUs. In embodiments, the SDEC 200h can prioritize critical traffic flows to ensure that they receive adequate power and bandwidth, while less critical traffic can be temporarily throttled or redirected to reduce power consumption.

Further, the SDEC 200h can help with network optimization. In embodiments, the SDEC 200h can aggregate multiple PON links to increase bandwidth and reduce power consumption per link. Further, in some embodiments, the SDEC 200h can adjust the optical power levels transmitted by an Optical Line Terminal (OLT) to optimize power consumption based on the distance to the ONUs 200e and the required signal-to-noise ratio. Still further, in example embodiments, the SDEC 200h can detect and diagnose power-related anomalies in the network, such as excessive power consumption or faulty components. Accordingly, the SDEC 200h can significantly reduce the overall energy consumption of a PON network such as in system 200.

Thus, the system 200 includes a combination of existing technologies and technologies currently being developed. However, all the illustrated communication technologies require energy or power to operate the communication equipment. The infrastructure of radio equipment, optical equipment, servers, routers, data storage, etc., all requires electrical power to operate. Moreover, transmitting data, whether over a wire, over a wireless network or over an optical fiber, requires substantial energy as well. And if the transmission requires multiple hops, from router to router or from network to network, each hop requires additional energy for communication. Still further, the noted technologies are not lossless. Optical devices can have manufacturing defects that absorb energy of transmission. Some materials inherently absorb energy of transmission. The PON network is a passive network. Energy is emitted and signals radiate from the source location. Signals cannot be boosted through any intermediate hops.

In embodiments, power or energy usage in the system 200 may be monitored and controlled from a centralized controller that may be located at any convenient location such as the central office 200a.

FIG. 2B illustrates some factors affecting optical signal strength of a signal transmitted in a fiber of a fiber optic system 202. The left side of FIG. 2B shows an exemplary optical transmitter 202a and an optical transmitter 202a coupled for data communication over a fiber link 202c. The fiber link 202c includes in the example a plurality of connectors 202d and a splice 202e. The example of FIG. 2B models a realistic, real-world fiber optic system 202.

The lower left portion of FIG. 2B shows optical power 202f along the length of the fiber link 202c. The optical power 202f is at maximum at the left-hand side, corresponding to the output of the optical transmitter 202a. The optical power 202f decreases along the length of the fiber link 202c. Each connector 202d or splice 202c corresponds to a stepwise drop in optical power as, as each connection, some power leaks or is reflected or absorbed. The length of the fiber introduces a fiber loss due to absorption or other phenomena. A minimal optical power 202f for adequate receiver sensitivity 202g is illustrated. Following the link loss 202h along the length of the fiber link, the margin 202i is relatively small.

The right portion of FIG. 2B illustrates spectral attenuation in a typical fiber for an operational range of wavelengths. Attenuation, measured in dB/km of fiber length, generally decreases with increasing wavelength. Generally, decay of optical signal strength or loss of light power during signal propagation is due to factors such as light scattering, bending losses as the fiber is bent mechanically, and light absorption in the material of the fiber. These factors impact the reachability of signals from source, such as optical transmitter 202a, to destination, such as receiver 202b.

In other examples, both single mode and multi-mode transmission of optical signals may be used. In multimode optical communication, multiple light rays, or modes, propagate simultaneously within a single optical fiber. This is in contrast to single-mode optical communication, which only allows a single mode to propagate. Multimode communication typically used for shorter distances due to modal dispersion, which can cause signal distortion over long distances. For example, multimode fibers may be commonly used in local area networks (LANs) to connect devices within a building or campus or in data centers for high-speed data transmission between servers and storage devices.

In other examples, different frequency bands are used for optical communication. Examples include C band (1530 to 1565 nm), offering low attenuation for long distance transmission and high bandwidth; L band (1570 to 1610 nm), offering even lower attenuation and longer distance transmission; S band (1460 to 1530 nm) for even lower attenuation and extremely long distance transmission; O band (1310 to 1360 nm), with low attenuation but a narrower range of wavelengths compared to the other bands; and E band (1360 to 1375 nm) offering low attenuation but a narrow range of wavelengths for transmission.

A further limitation in optical communication is Polarization Mode Dispersion (PMD). PMD is a phenomenon that occurs in optical fibers due to imperfections in the fiber's core, causing different polarization states of light to propagate at different speeds. PMD can lead to signal distortion and degradation, limiting the data transmission capacity of the fiber. Higher PMD levels can increase the bit error rate (BER), leading to errors in the transmitted data. PMD may occur due to manufacturing imperfections, bending and twisting of the fiber, and environmental factors such as temperature.

Another factor affecting optical communication is the structure or nature of the fiber itself. Some fibers are made with a fiber core and glass cladding. The fiber core is typically made of pure silica glass. The diameter of the core determines the number of modes that can propagate within the fiber. Single-mode fibers have a smaller core diameter, while multimode fibers have a larger core diameter. Glass cladding is usually made of silica glass with a lower refractive index than the core. The cladding surrounds the core and acts as a boundary, confining the light rays within the core. When light travels from a medium with a higher refractive index (core) to a medium with a lower refractive index (cladding), it can undergo total internal reflection if the angle of incidence is greater than the critical angle. This phenomenon keeps the light confined within the core. In another example, Wavelength-Division Multiplexing (WDM) Fiber can carry multiple optical signals simultaneously at different wavelengths, increasing the overall capacity of the fiber.

A further factor in an optical communication network is refractive index of the fiber. Refractive index is a property of optical materials that determines how light travels through the materials. Refractive index is a measure of how much the speed of light slows down when the light passes through a particular material compared to its speed in a vacuum. Different types of optical communication, such as multi-mode or single mode, will use different refractive indices. The refractive index also plays an important role in reaching a destination and in transmitted signal strength such as in FIG. 2B.

Thus, as FIG. 2B suggests, a fiber optic communication system is dependent on many physical properties such as the nature of the fiber, the distances for communication, and so forth. These factors need to be accommodated and designed for and adapted for in the implementation of the fiber optic communication system. Moreover, as FIG. 2A suggests, a fiber optic communication system is subject to a lot of topography challenges and changes in a network, including numbers of hops that need to be accommodated both in initially in designing the network and then in expanding the network.

There is thus a need for a system that can automatically take in all those inputs and variations and determine solutions for implementing or improving the network. Such a system may include a WDM-PON network that has the capacity and capability to learn characteristics of the entire PON network, perform data analytics and resolve network problems. Such a such may have software defined energy controller (SDEC) applications to collect parameters at design time and at run time and use that intelligence to learn characteristics of the WDM-PON network. This learning may be used to make intelligent decisions for the network while establishing an optimal launch channel energy, power and efficiency to ensure signals reliably reach their destination.

FIG. 2C is a block diagram illustrating an example, non-limiting embodiment of a software defined energy controller (SDEC) 204 functioning within the system 200 of FIG. 2A in accordance with various aspects described herein. For example, the SDEC 204 of FIG. 2C may implement functions of the SDEC 200h of FIG. 2A. In general, the SDEC 204 is in data communication with components of a WDM-PON such as system 200 of FIG. 2A. Such data communication enables collection by the SDEC 204 of data from the network components as well as command and control of the network components to manage operation and performance of the components of the system 200. In embodiments, the SDEC 204 includes applications and modules to collect parameters for a WDM-PON network at the time the network is assembled and at the time the network is activated to run and to use the collected information to actively learn characteristics of WDM-PON network. This developed intelligence, in turn, enables the SDEC 204 to make intelligent decisions in configuring the network while establishing the optimal launch channel energy, power and efficiency to enable signals communicated in the network to reach the destination.

In the illustrated embodiment, the SDEC controller 204 includes an SDN platform 204a, physical network interface 204b, a network interface 204c and a controller platform 204d. The SDN platform 204a defines a model-driven service abstraction and includes a data store. In the example, the data store includes a device layer database 204c, a network layer database 204f and a service layer database 204g. In embodiments, the data store further includes one or more databases for storing vector data, topology data, discovered data, network data, service data, and so on. The databases and the information stored therein may correspond to respective layers of the Open Systems Interface (OSI) model for network communication.

The physical network interface 204b includes hardware and software elements adapted to communicate with elements or components of the WDM-PON. For example, the physical network interface 204b may communicate with a Reconfigurable Optical Add-Drop Multiplexer (ROADM) or an Open Reconfigurable Optical Add-Drop Multiplexer (Open-ROADM). In the WDM-PON, the ROADM or Open-ROADM can add or remove specific wavelengths (colors of light) carrying data from a fiber optic cable and may be remotely configurable (i.e., by the SDEC 204). The ROADM or Open-ROADM can thus enable adjustment of traffic routing without physically modifying network infrastructure and can enable dynamic network provisioning. The physical network interface 204b may further interact with network devices such as controller switches and third party-provided equipment to manage the physical infrastructure of the WDM-PON network.

The physical network interface 204b may include any suitable hardware of software for performing the noted functions. In examples, the physical network interface 204b implements Network Configuration Protocol or NETCONF. NETCONF is a standardized protocol used to configure and manage network devices, such as routers, switches, and firewalls in a network such as a WDM-PON. In other examples, the physical network interface 204b implements OpenFlow, a software-defined networking (SDN) protocol that enables centralized control over network devices, such as switches and routers. OpenFlow decouples the control plane (the decision-making process) from the data plane (the actual forwarding of packets). In other examples, the physical network interface 204b implements Transmission Language 1 (TL1), a network management protocol to monitor and control network devices, and a command line interface (CLI) for operator interaction with network components. The physical network interface 204b may include any suitable application programming interfaces (APIs) for network interface, and the physical network interface 204b may access information such as API definitions from network tools 205.

The network interface 204c includes software and hardware to enable communication with internal systems of a network operator, such as the network operator which implements the WDM-PON for access by customers. The network interface 204c enables access by business applications of the network operator to information of the SDEC 204 and to control operation of the SDEC 204. Any suitable interfaces may be included in the network interface 204c including a web browser interface and any suitable application programming interfaces (APIs) enabling communication between internal network equipment and the SDEC 204. The network interface 204c may access information such as API definitions from network tools 205.

The controller platform 204d includes a set of utilities for functional application adaptation. The controller platform 204d operates to receive and collect parameters for the WDM-PON network and to use the collected information to actively learn characteristics of WDM-PON network. The controller platform 204d in turn, uses the developed intelligence, to enables the SDEC 204 to make decisions in configuring the network. Configuring the network may include identifying an optimal launch channel energy, power and efficiency to enable signals communicated in the network to reach the destination, and configuring the network elements to perform accordingly.

In the illustrated embodiment, the controller platform 204d includes a topology module 204h, a device discovery module 204i, a policy module 204j, a rule engine 204k, a training and testing module 204l, a channel launch power recommendation engine 204m, and a channel launch power recommendation engine 204m. In other embodiments, the controller platform 204d may include additional or alternative elements for performing similar or alternative functions.

The topology module 204h and the device discovery module 204i operate to develop an understanding of the optical components in the WDM-PON network including component capabilities, requirements and interconnections. The topology module 204h collects and stores information about the elements of the network and their interconnections, including details about physical structure of individual network nodes in the network and network branches of the network. Network nodes include devices such as transponders, routers, and switches that actively process optical information. network branches include fiber optic cables and connectors and other devices that convey optical information. Network branches connect network nodes.

In embodiments, the SDEC 204 connects to the devices of the network with the help of a south bound interface (SBI) adapter of the physical network interface 204b and applies all possible parameters and record the measured state. The SDEC 204 then runs a test transponder to each individual ROADM devices or node or network element and applies all possible parameters, and in turn collects the observation or result of applying the configurations. The topology module then collect data from a Jira document repository and Jira document management system, or other project management system. Further, the topology module collects data from all the logs file generated from the network elements deployed on existing brownfield topology.

The device discovery module 204i communicates with the physical network interface 204b and other sources to identify the components in the WDM-PON network. The device discovery module 204i service discovers the devices from the WDM-PON network. This may include devices from layer 0, layer 1, layer 2 and layer 3. Once the devices are discovered, the device discovery module 204i includes a collector engine that starts collecting the data.

The policy module 204j enforces the spectrum configuration policies to the devices or nodes or network elements of the WDM-PON network as per the recommendation rule engine 204k.

The rule engine 204k enforces the configuration rules defined by a network subject matter expert and further defined physical rules such as a network spectrum minimum and maximum threshold. Further, the rule engine 204k controls the policy module 204j to activate the policy enforcement to the devices or nodes or network elements of the WDM-PON network. Further, the rule engine 204k maintain a state of action taken and calculates the reward and plenty of each individual action taken by the rule e204lngine and ranks the actions.

The training and testing module 204l process data collected by the topology module 204h. The training and testing module performs the data computation process according to computations formulas provided and data collected. This procedure creates the dataset with all the possible train and test data preparation. The training and testing module 204l trains the artificial intelligence model and at the same time it also text embeds fully connected layer vector geometric data to a vector database. Once model training is done, training and testing module 204l tests the model accuracy and also tests the accuracy of search data from the vector database.

The channel launch power recommendation engine 204m is used to predict the optimum optical efficient channel launch power that should be used between each source and destination end point of the WDM-PON and network. Predicted launch power response from a vector database for the given prompt is fine-tuned with the help of a large language model (LLM). The channel launch power recommendation engine 204m recommends the optimum optical channel launch power between end points of each source and destination endpoint of the WDM-PON network.

FIG. 2D depicts an illustrative embodiment of a system modeling process 206 in accordance with various aspects described herein. The system modeling process 206 may be implemented in conjunction with the SDEC 204 of FIG. 2C to model aspects of a WDM-POM such as the system 200 of FIG. 204A.

The SDEC 204 collects data from data sources in the network such as data source 206a associated with system 206b. The system 206b may include some or all components and network branches of the WDM-POM network, for example. The collected data is collected from every network node and every network branch and includes optical characteristics, measurements and other information pertinent to the optical communication in the system 206b. Moreover, as aspects of the network change over time, the collected data is updated to maintain a current view of network conditions and configuration. In response to the data collection, the SDEC 204 begins measuring and computation based on the data in a learning process 206d. Data may be stored in a vector database at the SDEC or at another suitable location.

The collected data and computation results from the learning process 206d may be used to form an embedding model 206e. An embedding model is a machine learning technique that maps high-dimensional data, such as text or images, into a lower-dimensional space. This process is known as embedding. Embedding models can significantly reduce the dimensionality of data, making it easier to process and analyze. The embeddings can be used to measure the similarity between different data points. Embeddings can be visualized in a low-dimensional space, providing insights into the underlying structure of the data. For example, word embeddings can be used to represent words as numerical vectors, capturing semantic relationships between words. In another example, graph embeddings can be used to represent nodes and edges in a graph as numerical vectors, capturing relationships between entities in the graph. In examples, embedding models may be used in conjunction with recommendation systems, such as for suggesting items to users based on their preferences or past behavior, or in graph analysis for community detection, link prediction, and knowledge graph completion. For the text-based embedding model 206e of FIG. 2D, data is converted into a geometric format of data and stored in a vector database.

The embedding model 206e may be used to make recommendations, such as model parameters 206f, based on inputs to the model. Based on the recommended outputs from the embedding model 206e, a response may be created. In the illustrated embodiment, the output is taken as fully connected embedded model and stored in the vector database. A fully connected model output is the final result produced by a neural network where every neuron in one layer is connected to every neuron in the next layer. Then, the model 206e may be given inquiries as inputs. In examples, the model 206c may be given a possible network scenario as an input and will generate three possible best responses for the given scenario. The model 206 is constantly updated with additional data. Rather than being retrained, the model 206e is updated to a more accurate model. Improving accuracy corresponds to reducing Euclidean distances for all the responses. In example embodiments, the output from the model 206e may be provided to a large language model (LLM) to identify a most optimal solution for a given scenario for the system 206b.

Thus, the model 206e is given an input and returns a recommendation. The model 206e returns the three (or other selectable number) best responses, based on Euclidean distance between input parameters and the three output values. The model 206e does not produce a prediction but produces a recommendation.

FIG. 2E depicts an illustrative embodiment of a system 210 for managing optical transmitter channel power, energy, and efficiency in a wavelength division multiplexing passive optical (WDM-PON) network. In the exemplary embodiment, the system 210 includes network data 210a, network data 210b, embeddings generator 210c and embeddings generator 210d, and vector database 210e. The system 210 further includes network logs 210f and filter module 210g. In the illustrated embodiment, the system 210 further includes a collaboration platform 234 that may interact with personnel such as a human user 232, a collaboration handler 236, a prompt and recommendation engine 238, an action handler 240, and a large language model 226.

The network data 210a and network data 210b correspond to information about devices in the WDM-PON network. In a typical embodiment, the WDM-PON network incorporates devices manufactured by several different vendors. While the devices cooperate to communicate data over the PON, the devices may use and store different types of control data and diagnostic data. Each device may use a different grammar for control and reporting, where the grammar includes commands, variables, reported values and data. Each device may be represented by a different, unique and custom data model These data may be in different formats and may not be readily compatible or combinable. Examples include transmission language 1 (TL1) data for some devices, Yang Model (YANG) data for some devices, extensible markup language (XML) data for some other devices, as shown at network data 210a. These differences among the network nodes must be accommodated in managing and controlling the system 210.

The network data 210a may include, for example, configuration data for devices in the communication network. In other examples, the network data 210a may include prediction data produced by an artificial intelligence or machine learning model. For example, some aspects of an existing data set may be provided to the model and the model, in turn, generates a prediction based on the input parameters.

The network data 210a may be received at an interface which is configured to receive data from the different network devices. The data forming network data 210a may be loaded to embeddings generator 210c and used for learning. The data from the network devices is received and used in a learning process and stored in the vector database 210c.

Similarly, network data 210b may include Jira data from the Jira project management tool. For example, the Jira data or other data of the network data 210b may include information about technical specifications or capabilities or limitations of network elements including network nodes and network segments. The Jira data may include product documentation for network devices, for example. Other examples include information about available bandwidth or data rates at particular network devices, minimum requirements for some functions or components, information about how much power may be required or can be supplied, information about efficiencies, information about the types of optical fiber that is in place in a network segment, such as single mode fiber or multimode fiber, as well as the refractive index of the fiber. Such data may further include information about problems in the network or a network device. Such data may be provided to the system 210 at the time equipment is installed. Further, such data may be provided and updated to the system at the time equipment is changed out or upgraded or taken offline. The Jira data may be used at a time when it is desired to configure an interface, for example. The Jira data of network data 210b may be consulted to learn the necessary steps and order of steps for configuring the interface, etc. The data at network data 210b may be loaded to embeddings generator 210d. Contents of the embeddings generator 210c and the embeddings generator 210d may then be embedded into the vector database 210e or used to form an embedding model.

The network logs 210f include information about the actual operation of the WDM-PON. The network logs 210f include in the illustrated example audit logs, event logs, error logs, etc. The different network logs 210f record information about past events and traffic that occurred in the PON. For example, a bit error rate (BER) exceeding a predetermined threshold in a particular network segment may be recorded in an error log with information such as a time stamp, network address, and details about the actual errors that occurred. The network logs 210f store data about past operation of the existing infrastructure.

In embodiments, a loader and filter module 210g operates to retrieve selected information from the network logs 210f. In particular, the loader and filter module 210g locates anomalies in the data of the network logs, such as persistent failures of a certain kind or at a certain location. The anomaly data may be helpful to predict an optimal network design. The anomaly data and any other data of interest may be stored by the loader and filter module 210g as embeddings in the vector database 210c. For example, in a network design phase, a certain efficiency may be predicted for the network. In implementation, though, the actual efficiency may be less than predicted, due to many factors. The information contained in the network logs 210f may be useful in understanding the variation in performance from design.

In another example, polarization mode dispersion (PMD) may occur in optical fibers because of imperfections in the fiber's core. These imperfections cause light waves with different polarizations to travel at slightly different speeds, leading to distortion and degradation of the optical signal. If PMD is prominent, it can affect reachability in the network. In that case, the log of messages and other information in the vector database 210e may assist in diagnosing the problem. For example, if data is transmitted with a known power and the expectation that it will reach from the source to the destination and the data is not received, a fault will be detected. Information about the fault and the network can be used to identify the problem. Such information includes network topology, manufacturer of a network node and manufacturer of the fiber, what types of optical fiber is being used, etc. This information may be used to develop a recommendation or multiple recommendations to improve the network.

Referring now to FIG. 2F, it shows a modelling process 220 in accordance with various aspects described herein. The modelling process 220 includes an embedding model 222, a learning process 222a, a nearest neighbor search tool 224, and a large language model 226. The learning process 222a may correspond in some respects to the operation of embeddings generator 210c and embeddings generator 210d in FIG. 2E. The learning process 222a receives a large number of text documents 228. In the example embodiment of FIG. 2E, the network data 210a and the network data 210b may form the text documents 228 that are the inputs to the embedding model 222. As noted, the network data 210a and the network data 210b may include in embodiments text documents defining organization and topology of the network, aspects of the devices and components of the network such as composition and structure of optical fibers and optical components such as ONUs and ODNs. Further, the network data 210a and the network data 210b may include Jira data in the form of text documents with information about operation and failures in the network. The text document 228 are used to train the embeddings model 222.

An embedding model is a technique used to represent complex data, such as words, images, or documents, as dense vectors in a lower-dimensional space. Such vectors are called embeddings. In embodiments, the embeddings model 222 is a word-based embeddings model. A word-based embedding model is a type of machine learning technique used to represent words as dense vectors in a lower-dimensional space. These vectors, known as word embeddings, capture the semantic relationships between words. For example, word embeddings capture the semantic relationships between words. Words with similar meanings tend to have similar embeddings.

The embeddings model 222 may be trained using the text documents 228 in any suitable manner. In the example of FIG. 2E, the embeddings generator 210c and the embeddings generator 210d perform or manage a learning process 222a by which the embedding model 222 is generated. Further, in FIG. 2E, the embeddings model 222 may be stored in the vector database 210e.

Referring again to FIG. 2D, the data source 206a may include the text documents 228 of FIG. 2F, again corresponding to the network data 210a and the network data 210b of FIG. 2E. Information from the data source 206a may be applied to the system 206b as well as used in training process 206c through a learning process 206d to train the model 206e. The model 206e may correspond to the embeddings model 222 and may be used to provide a prediction or a recommendation based on a set of existing data.

In example embodiments, the process 220 of FIG. 2F and the system 210 of FIG. 2E may operate to calculate the following parameters of an optical fiber based upon different combinations of provisioning parameters.

Spectral efficiency (SE) for all the combinations of modulation formats with bandwidth. SE=Log₂(M)÷(N/2), where M is number of symbols and N is dimensionality.

Asymptotic Power Efficiency APE=gama=d²ₘᵢₙ/4E_{b}=d²ₘᵢₙ log₂(M)/4 Eₛ

$$Average symbol rate {E}_{s} = \frac{1}{M} {\sum }_{k = 1}^{M} {‖ {c}_{k} ‖}^{2}$$

Average energy per bit is A E_{b}=Es/Log₂ (M)

Attenuation: α_{db}*L=10 log₁₀ Pi/Po, where α_{db} is signal attenuation per unit length in decibel and L is optical length. Pᵢ is launch power and Pₒ is received power.

Stimulated Brillouin Scattering (SBS: P_{B}=4.4×10⁻³ d² λ² α_{dB}ν watts

Stimulated Raman Scattering (SRS): P_{R}=5.9×10⁻²d² λα_{dB} watts, where d and λ are fiber core diameters and operating wavelength measured in micrometers. α_{dB} is fiber attenuation in dB per kilometer and ν is bandwidth of injection laser. Computation of SBS and SRS thresholds may help keep launch powers of channels in control to avoid these scatterings in fiber.

Referring again to FIG. 2F, once the embedding model 222 is established, an input query 230a is received by the modelling process 220. The input query 230a may ask for a recommended set of attributes for a particular aspect of the system 200 (FIG. 2A). For example, for a WDM-PON transmitter in the central office 200a communicating with the ODN 200d, what are the recommended parameters to achieve a data rate of 100 Mbps? The embedding model 222 will generate an output 230b which serves as an input to the nearest neighbor search tool 224. The nearest neighbor search tool 224 will return one or more maximum probability responses based on a minimum Euclidean distance. In an example, the nearest neighbor search tool 224 provides three responses 224a.

The three responses 224a from the nearest neighbor search tool 224 are in turn provided to the large language model 226. A large language model (LLM) is a type of artificial intelligence that is trained on a massive amount of text data. Such models are designed to understand, generate, and manipulate human language. Such models can generate human-quality text, such as articles, stories, and scripts. Such models can understand the context of a conversation or a query and can respond in a relevant and informative way. Any suitable LLM may be used for the large language model 226, including generally developed models or models developed specifically for the noted purpose of network development and refinement. I

In general, the large language model 226 implements a retrieval augmented generation (RAG) pipeline. This refers to a technique that combines a traditional LLM with a retrieval system. When prompted with a query, the LLM 226 first searches a large knowledge base similar to a corpus of text or documents to find relevant information. The retrieved information is then integrated into the response generation process of the LLM 226. This can involve directly incorporating the relevant text into the response or using the retrieved information to guide the LLM's generation process. By accessing and incorporating relevant information, RAG can help LLMs generate more accurate and informative responses. RAG can ensure that the LLM's responses are more relevant to the specific query, reducing the likelihood of generating irrelevant or misleading content. Further, RAG can be used to equip LLMs with domain-specific knowledge, enabling them to perform tasks like answering questions about fiber optic devices and networks, as in the present example.

In an example, the nearest neighbor search tool 224 identifies one or more network components to be modified and specifies the commands to be executed on those network components to implement a reconfiguration to achieve the goals of the input query 230a. However, a human operator may not know an appropriate sequence of commands to give to the network equipment to implement the change. Thus, the responses 224a from the nearest neighbor search tool 224 may form an input query to the large language model 226 specifying modifications to make to specified network elements and requesting a command sequence appropriate to successfully make the modification. The large language model 226 may provide a response 226a specifying the necessary commands.

Referring again to FIG. 2E, a user 232 may interact with the system 200 to develop aspects of the system. In the illustrated example, the user 232 may interact with the collaboration platform 234 to develop optimal network element settings for a WDM-PON network. In a particular example, the user 232 may seek to establish network element settings for optimal launch channel energy, power and efficiency. The user 232 may provide suitable inputs such as an input query to the collaboration platform 234 for forwarding as user action or input query 230a to the collaboration handler 236. The collaboration handler 236 may process the input query 230a into a suitable format and provide additional context 226b. In turn, the prompt and recommendation engine 238 interacts with the vector database 210e, which implements the embeddings model 222 and the nearest neighbor search tool 224 (FIG. 2F). Based on the input query 230a, the nearest neighbor search tool 224 returns one or more (e.g., three) responses having maximum probability for achieving the goal of the input query 230a.

The three responses may be provided directly to the user 232 as recommendations or responses 226a for review and approval. Alternatively, the three responses may be passed to the large language model 226 for evaluation and further development. For example, the three responses 226a may specify a set of settings for a network device to achieve the goals of the input query. However, to determine a correct sequence of commands to implement the set of settings, the set of settings may be passed in the form of a suitable command to the large language model 226. The query may be in the form of a text query asking for the proper sequence of instructions to program a specified network element to a specific operating set point. The large language model 226 returns the requested sequence of instructions to the prompt and recommendation engine 238 which may forward them to the collaboration platform 234 for review and approval by the user 232.

Upon review and approval by the user 232, the prompt and recommendation engine 238 may pass information about the sequence of instructions and identification information for the network device to the action handler 240. The action handler 240, in turn, may interact with the software defined network device 210f to create network commands for communication over a network 242 to the network element of interest. The communicated commands are based on the sequence of instructions developed by the large language model 226 based on one of the three solutions generated by the embedding model 222 and the nearest neighbor search tool 224. The commands communicated over the network 242 cause the network element of interest to be configured or reconfigured to achieve the goals specified by the input query 230a.

In embodiments, the system 210 may form a software defined energy controller (SDEC) for a WDM-PON network, the SDEC incorporating a topology manager and an artificial intelligence and machine learning system. A model such as the embedded model of the vector database 210e may predict and recommend optimal energy, power and efficiency for an optical launch channel in the WDM-PON network. Different portions of the WDM-PON may have flexible modulation formats, adaptive forward error correction (FEC), use flexible data rates, and flexible data types, etc. The SDEC for WDM-PON network may receive information about network infrastructure including types of network elements and vendors of the network elements, including full product specifications, as well as types of fiber optic cable used including single mode and multimode cable and types of cladding used on the cable. Based on all this received information, the SDEC for the WDM-PON network may tune a channel (i.e., specific center frequency), select a bandwidth and predict optimal optical channel with efficient energy, power and channel efficiency in the PON network.

In an example, a WDM-PON includes a particular manufacturer's or vendor's Roadm-Based Optical Amplification Module (ROADAMP) operating as a transponder. The device amplifies the optical signal to compensate for signal degradation that occurs due to fiber attenuation over long distances. In embodiments, the device can selectively route different wavelengths of light to different destinations, enabling efficient multiplexing of data streams on a single fiber. Further, embodiments enable add/drop Multiplexing (ADM), which allows for the addition or removal of specific wavelengths from the optical signal, which is essential for network flexibility. A ROADM is a reconfigurable Optical Add/Drop Multiplexer.

In the example, one of the ROADAMP devices is located at one end of a connection and a different vendor's device is located at the other end of the connection, referred to as the A-end and the Z-end respectively. Having equipment from a mixture of vendors is a common occurrence in optical networking.

In the connection between the transponders at the A-end and the Z-end, there may be routers from different vendors. Different equipment by different vendors have different operating aspects. These individual operating aspects must be considered when designing or configuring a network or a connection. This is particularly true when designing for low-power consumption is an important design goal or the main design goal for the network.

For example, design parameters for a connection include a distance between connection points, a center frequency to use for communication, a bandwidth to use for communication, a transmission power required for communication, a modulation scheme, such as Quadrature Amplitude Modulation (QAM), quadrature phase shift keying (QPSK) and differential phase shift keying (DPSK). Each of these parameters must be selected for the connection, and each may have different importance of effects for each vendor's device.

The information about all the vendors' devices and capabilities cannot be readily held in the vector database 210c. In the example, three devices from three vendors are available to use in the network, and an overall design goal is reduction or minimization of operating power required by network devices. This is where the LLM 226 may assist in making a decision for network parameters and design. The prompt and recommendation engine 238 may pose a query to the LLM 226 specifying three candidate devices on each end of the connection, such as the A-end and the Z-end. The device-specifying information may include, for example, a manufacturer or vendor name, a model number, and any other information that may be useful to the LLM 226 to characterize the device and its operation. Further, the query may specify a center frequency for use in the connection. And the query may ask the LLM 226 to provide the power consumption for all three candidate devices.

Based on the results of the query, decisions can be made by the human operator or designer about what devices to select. Alternatively, based on the results of the query, and other queries on related issues, a decision can automatically be made which achieves the stated design goal (such as minimizing power consumption), and then automatically implemented in the network.

Many other factors may be the subject or form the content of queries to the LLM 226. For example, such factors may relate to signal losses in the components of the PON. Queries may include information about technology or devices, such as information about the number of hops between the A-end and the Z-end of the connection, information about the number of connectors, number of spaces, number of connections with the fibers, information about the nature of the optical fiber such as multimode or single mode, or the type of fiber core or cladding, information about manufacturing defects, and so forth.

Thus, the queries to the LLM 226 are based on information derived from the vector database 210e and directed toward a design goal for the WDM-PON network or an operational goal for one or more network devices of the WDM-PON network. The design goal in this example is minimizing power consumption in a connection of the PON. Other design goals may be specified, such as reducing or minimizing cost of the equipment used, or improving a performance parameter such as an error rate above a specified threshold. The responses from the LLM 226 provide information that is not otherwise readily available to assist in making design choices. Such design choices include selection of equipment (e.g., from one vendor or another) and selection of components (such as one fiber type or another).

The LLM 226 produces a recommendation. The recommendation may involve, for example, a modification to the PON. In embodiments, the operator of the network determines if the recommendation will affect the existing network. For example, the recommended change, if implemented, will affect traffic and users in the existing network. In that case, the network operator may advise operators such as the user 232 about the recommendation. The recommendation may become part of operator training or network management protocol. For example, the operators may be trained that, if a particular situation arises in the network, a set of steps or procedures form the appropriate action to take to resolve the situation. When faced with the particular situation in the future, the operators including user 232 may follow the set of steps or procedures to resolve the situation. In the example, the situation and the resolution are part of the recommendation from the LLM 226.

When the LLM recommendation affects network capacity or capability, it is not implemented automatically by the system 210 but rather becomes part of network operating procedure for trouble shooting and issue resolution. For example, over time, the operators and network operator learn that the prescribed response is the correct response to take when a particular situation arises. Thus, there is an aspect of self-learning, in which personnel perform the same set of actions to resolve a situation and come to recognize the standard resolution.

In other examples, the recommendation from the LLM 226 is not complex or does not affect traffic in the PON. For example, the recommended modification may just affect an operating parameter of one or more devices that may be adjusted by a user 232 or other operator. No network component or connection is required to be taken offline or restarted. In that case, the recommended configuration can be automatically applied to the network equipment.

FIG. 2G depicts an illustrative embodiment of a method 250 in accordance with various aspects described herein. The method 250 may be used to configure or reconfigure portions of a wavelength division multiplexing-passive optical network (WDM-PON). The method 250 may be performed at any convenient location such as a location in data communication over a network with network elements of the WDM-PON. For example, the method 250 may be performed at a data processing system of a central office or a core network of a network operator. The method 250 may be initiated in response to any input including, for example, a requirement to optimize a network operating parameter such as power dissipation or power usage in the WDM-PON.

Initial preparatory steps of the method 250 relate to creating artificial intelligence or machine learning models for use by the method. At step 252, a first model is built. In embodiments, the model is an embedded model. In particular embodiments, the model is a word-based embedded model. However, any other suitable model or combination of models may be used.

At step 254, the model is trained. In an example using an embedded model, a large corpus of text may be collected. The text may include, for example, configuration information about the WDM-PON, such as information identifying network elements or nodes and the network segments that connect the nodes, and physical information such as locations of the network elements, composition of optical fibers forming network segments, etc. The text may further include information about technical capabilities and physical specifications for the network nodes and segments, including for example, a manufacturer and model number of a particular element, operating frequencies and bandwidth, types of interconnections, etc. The text forming the corpus may include any suitable or available information. Further, the model may analyze the corpus to identify how often words appear together. A high-dimensional vector space is created. Each word is assigned a unique vector in this space. The model maps words to their corresponding vectors based on their co-occurrence patterns. Words that appear together frequently will have similar vectors, indicating semantic similarity. Any other suitable training or model preparation steps may be taken as well.

At step 256, a large language model (LLM) may be built. In some examples, the LLM may be a conventional or commercially available LLM which is modified or adapted for use with an optical communications network. For example, a dataset of information about manufacturers' optical network components may be assembled and then used to train or fine-tune an existing model. This may involve adjusting the model's parameters to better align with the specific tasks or domains of an optical communication network.

At step 258, after the models have been built and configured, the opportunity arises to use the models. A request may be received to configure or reconfigure some aspect of the PON. For example, if a new segment or branch of the network is being designed, the request might specify a transponder to be used at one end, such as the A-end of the connection, and another transponder to be used at the Z-end of the connection. The query received at step 258 may then ask to specify a type of optical fiber for the connection and specify the distance and required data rate for the connection.

At step 260, information based on the request is provided as an input to the model. For example, the details noted above for step 258 may be provided to the embedded model. Any other data preparation or configuring may be done prior to providing the request to the model.

At step 262, one or more recommendations are received from the embedded model or other model. In some applications, the model may provide three recommendations that best satisfy the request received at step 260. In other applications, the model may provide five recommendations. The number of recommendations may be programmable or selectable. In general, the recommendations are produced by a nearest-neighbor search tool which locates and produces the highest probability responses, or those having a minimal Euclidean distance to the input request.

Also, at step 262, a query based on the received recommendations is provided to the LLM. In some embodiments, the LLM is associated with a retrieval augmented generation (RAG) pipeline to combine information retrieval and natural language generation. In the RAG pipeline process, the query is processed and understood, relevant information is retrieved from the corpus of text, and a language model is used to generate a useful response to the query.

At step 264, a recommendation is received from the LLM in response to the query. In the example, the query may ask the LLM to categorize three recommended solutions provided by the embedded model at step 262 according to some standard. An example is, of the three manufacturers' transponders recommended by the embedded model, which would provide a lowest power usage?

Further, an iteration process may occur using the RAG pipeline process. At step 266, the method 250 may determine if an optimal solution has been reached. For example, other possible modifications could be made such as selecting a different center frequency or bandwidth for communication on the network segment. If no optimal solution has been reached, control returns to step 262 for further interaction with the LLM. The method 230 may continue in a loop including step 262, step 264 and step 266 until an optimal solution is identified.

At step 268, a network element under consideration may be configured or reconfigured according to the solution provided by the LLM. Such configuring and reconfiguring may be performed in any suitable manner. In one example, a software defined network may assemble a sequence of commands necessary to configure or reconfigure the network element of interest and then communicate the sequence of commands to the network element. When the sequence of commands is received by the network element, they cause the network element to automatically reconfigure itself according to the recommendation from the LLM. Any other suitable method of configuring or reconfiguring the network element may be substituted.

From the foregoing, it can be seen that embodiments in accordance with various aspects described herein implement a Software define energy controller (SDEC) in a WDM-PON network. The SDE controller includes a topology manager, artificial intelligence and a Machine Learning system. The SDE controller operates to predict and recommend optimal energy, power, and efficiency for an optical launch channel in the WDM-PON network. This enables the WDM-PON to have flexible modulation formats, adaptive forward error correction (FEC), flexible data rates, flexible data types etc. Based on information produced by the system and method, the WDM-PON network may tune the channel frequency and bandwidth and predict an optimal optical channel with efficient energy, power and channel efficiency in the PON network. The system and method implement a novel way of doing allocation of the spectrum with the help of the SDE controller to predict optimal channel launch energy, power and channel efficiency in the WDM-PON network. Further, the system and method resolve the problem of creating a hole in the available spectrum for freshly launched channels. Still further, the system and method use artificial intelligence/machine learning and a retrieval augmented generation (RAG) pipeline model algorithm to predict channel spectrum with minimal and efficient channel launch power. The algorithm makes use of SDE controller knowledge to compute the impact for each movement of channel and channel launch power.

Further, spectrum is very precious in WDM-PON networks. Using the embodiments of the disclosed system and method, an SDE controller may utilize the spectrum with maximum utilization during frequency channel network patterns and recommends smart frequency channel with optimal launch power efficiency. Moreover, the system and method can help save operation expenditures by predicting WDM-PON frequency channel network patterns having optimal channel launch power.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

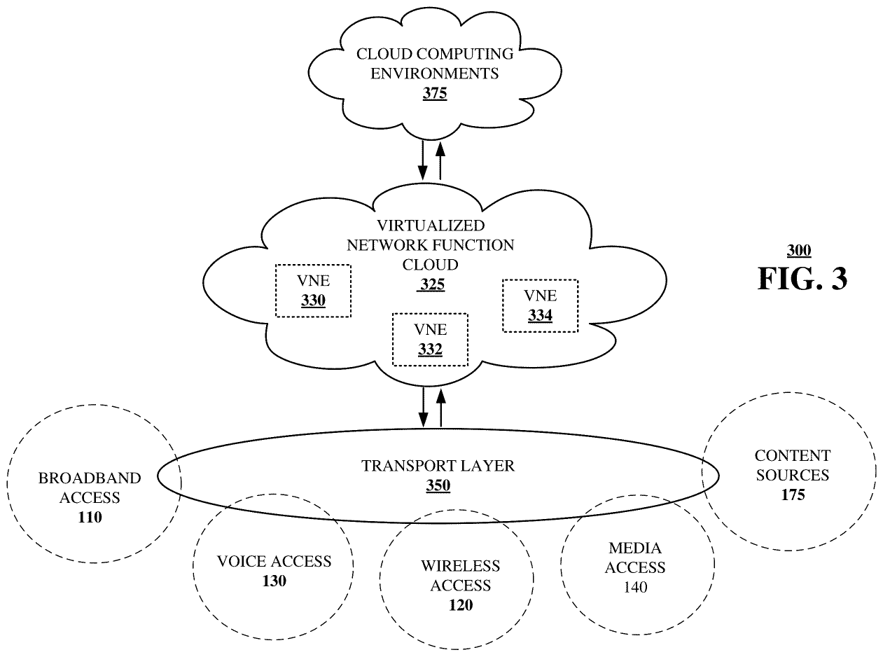

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, system 204, system 206, system 210, system 220, and method 250 presented in FIG. 1, FIG. 2A, FIG. 2C, FIG. 2D, FIG. 2E, FIG. 2F, FIG. 2F and FIG. 3. For example, virtualized communication network 300 can facilitate in whole or in part collecting information about network nodes and branches for an optical communication network, forming an embedded model based on the information, providing maximum probability responses in response to an input query, providing a query based on the maximum probability responses to a large language model, and receiving, from the large language model, information to improve performance of one or more aspects of the optical network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

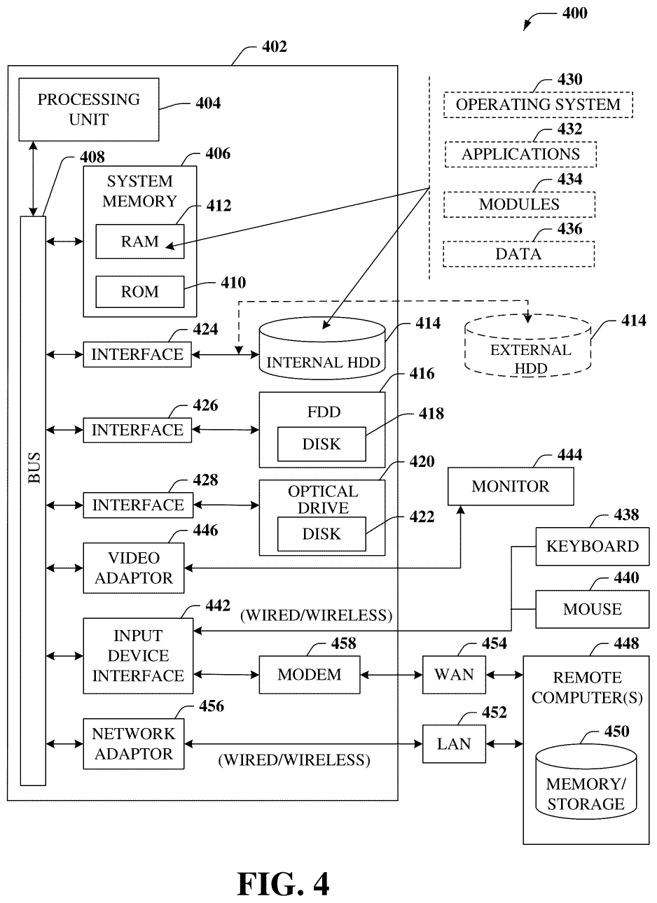

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part collecting information about network nodes and branches for an optical communication network, forming an embedded model based on the information, providing maximum probability responses in response to an input query, providing a query based on the maximum probability responses to a large language model, and receiving, from the large language model, information to improve performance of one or more aspects of the optical network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

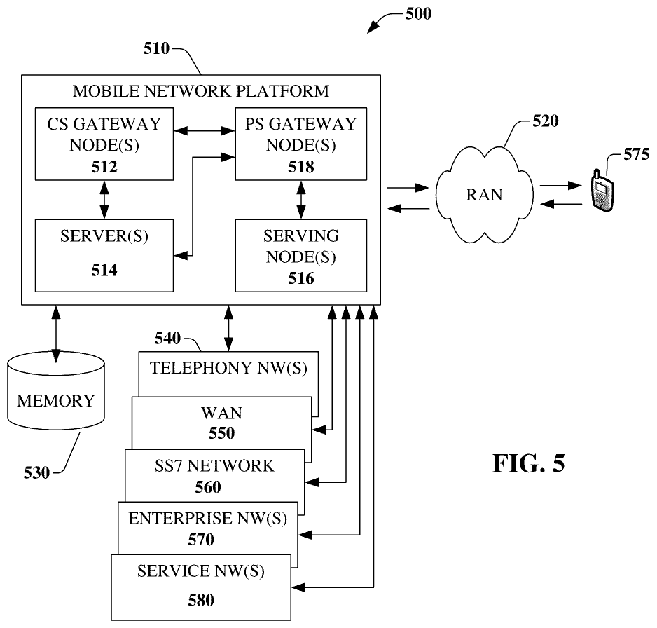

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part collecting information about network nodes and branches for an optical communication network, forming an embedded model based on the information, providing maximum probability responses in response to an input query, providing a query based on the maximum probability responses to a large language model, and receiving, from the large language model, information to improve performance of one or more aspects of the optical network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

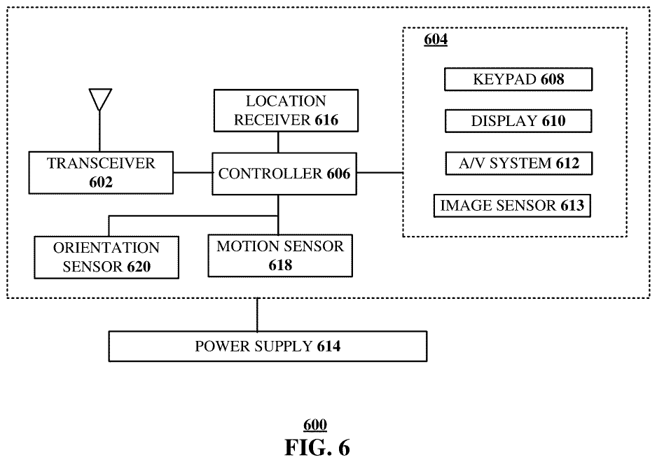

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part collecting information about network nodes and branches for an optical communication network, forming an embedded model based on the information, providing maximum probability responses in response to an input query, providing a query based on the maximum probability responses to a large language model, and receiving, from the large language model, information to improve performance of one or more aspects of the optical network.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting information about network nodes and network branches in a waveform-division multiplexing-passive optical network (WDM-PON);
forming an embedding model based on the information about network nodes and network branches;
receiving an input query;
providing, by a nearest-neighbor search tool associated with the embedding model, one or more maximum probability responses in response to the input query;
providing a query based on the one or more maximum probability responses to a large language model; and
receiving, from the large language model, information to improve performance of one or more aspects of the WDM-PON.

2. The device of claim 1, wherein the collecting information about network nodes and network branches comprises:
collecting information about configuration of the network nodes and the network branches;
collecting information about technical specifications and capabilities and limitations of the network nodes; and
collecting information about types of optical fiber in place in respective network segments.

3. The device of claim 1, wherein the operations further comprise:
receiving text documents about the network nodes and network branches; and
training a word-based embedding model based on the text documents.

4. The device of claim 1, wherein the operations further comprise:
receiving, from the nearest-neighbor search tool, information about one or more network components to be modified to improve performance of one or more aspects of the WDM-PON; and
providing, to the large language model, an inquiry specifying the one or more network components to be modified.

5. The device of claim 4, wherein the receiving the information about one or more network components to be modified comprises:
receiving, from the nearest-neighbor search tool, commands to be executed on the one or more network components to be modified, the commands operative to implement a reconfiguration of the one or more network components to improve performance of the one or more aspects of the WDM-PON.

6. The device of claim 5, wherein the providing, to the large language model, the inquiry comprises:
providing, to the large language model, a query specifying the commands to be executed on the one or more network components to be modified and requesting from the large language model a command sequence appropriate to successfully implement the reconfiguration of the one or more network components to improve performance of the one or more aspects of the WDM-PON; and
receiving, from the large language model, a response including the command sequence.

7. The device of claim 6, wherein the operations further comprise:
automatically providing, to the one or more network components to be modified, the commands to be executed on the one or more network components to be modified and the command sequence, wherein the commands to be executed on the one or more network components to be modified are operative, when performed in the command sequence, to implement the reconfiguration of the one or more network components to improve performance of the one or more aspects of the WDM-PON.

8. The device of claim 7, wherein the operations further comprise:
producing, by a software defined network device, network commands for communication over a network to the one or more network components to be modified, wherein the network commands are based on the command sequence.

9. The device of claim 1, wherein the receiving an input query comprises:
receiving first information about candidate network devices to serve as a first device on an A-end of a connection in the WDM-PON and to serve as a second device on a Z-end of the connection in the WDM-PON;
receiving information defining a center frequency for use in the connection in the WDM-PON; and
receiving a request for the large language model to provide information about power consumption by the candidate network devices if selected to serve as the first device and the second device on the connection in the WDM-PON.

10. The device of claim 1, wherein the receiving an input query comprises:
receiving an inquiry based on the embedding model and directed toward an operational goal for one or more network devices of the WDM-PON.

11. A non-transitory machine-readable medium, comprising executable instructions that, when executed by a processing system including a processor, facilitate performance of operations, the operations comprising:
providing, to an embedding model, operational requirements information for a possible network scenario for an optical communication network;
receiving, from the embedding model, a plurality of recommendations for satisfying the possible network scenario;
providing the plurality of recommendations to a large language model;
receiving, from the large language model, a response, wherein the response includes information recommending operational features and network devices which are adapted to satisfying the possible network scenario; and
modifying the operational features or the network devices, or both, according to the response from the large language model.

12. The non-transitory machine-readable medium of claim 11, wherein the operations further comprise:
providing operational requirements information to a fully connected embedded model; and
receiving the plurality of recommendations based on a minimized Euclidean distance determined by the fully connected embedded model.

13. The non-transitory machine-readable medium of claim 11, wherein the operations further comprise:
providing, to the embedding model, information about configuration of network nodes and network branches of the optical communication network;
providing, to the embedding model, information about technical specifications and capabilities and limitations of network nodes of the optical communication network; and
providing, to the embedding model, information about types of optical fiber in place in respective network segments of the optical communication network; and
requesting, of the embedding model, a recommended set of attributes for one or more network elements of the optical communication network.

14. The non-transitory machine-readable medium of claim 11, wherein the operations further comprise:
providing, to the embedding model, a desired data rate for a specified network segment of the optical communication network; and
receiving, from a nearest-neighbor search tool associated with the embedding model, three recommendations for providing the desired data rate for the specified network segment of the optical communication network, the three recommendations based on a minimum Euclidean distance between the desired data rate and the three recommendations.

15. The non-transitory machine-readable medium of claim 11, wherein the operations further comprise:
providing, to the large language model, a request to identify an optimal power level for data transmission in the optical communication network, based on a current infrastructure configuration for the optical communication network.

16. A method, comprising:
receiving, by a processing system including a processor, network infrastructure information defining structural aspects and functional aspects of a passive optical network (PON), the PON including network nodes and network branches which connect the network nodes;
receiving, by the processing system, a request to define one or more optimal operational characteristics of the PON;
receiving, by the processing system, from an embedded model, a plurality of recommendations for network devices, the plurality of recommendations selected to facilitate the one or more optimal operational characteristics of the PON;
providing, by the processing system, the plurality of recommendations to a retrieval augmented generation (RAG) pipeline including a large language model (LLM);
receiving, by the processing system, from the RAG pipeline, a recommendation defining the one or more optimal operational characteristics of the PON; and
initiating, by the processing system, a modification to one or more network devices according to the recommendation.

17. The method of claim 16, comprising:
receiving, by the processing system, first textual information about configuration of the network nodes and the network branches;
receiving, by the processing system, second textual information about technical specifications and capabilities and limitations of the network nodes;
receiving, by the processing system, third textual information about types of optical fiber in place in respective network segments; and.
training, by the processing system, the embedded model based on the first textual information, the second textual information and the third textual information, forming a word-based embedded model.

18. The method of claim 16, comprising:
receiving, by the processing system, a request to define a minimal channel power for a portion of the PON;
receiving, by the processing system, from the RAG pipeline, a recommended channel spectrum for the portion of the PON, the recommended channel spectrum based on the minimal channel power for the portion of the PON; and
communicating, by the processing system, operating commands to the one or more network devices to configure the one or more network devices for operation on the recommended channel spectrum.

19. The method of claim 18, comprising:
receiving, by the processing system, from the LLM, a command sequence for the operating commands; and
communicating, by the processing system, the command sequence to configure the one or more network devices.

20. The method of claim 16, wherein the receiving the request to define one or more optimal operational characteristics of the PON comprises:
receiving, by the processing system, a request to define one or more of a modulation format, a forward error correction technique, a data rate, a data type, a channel frequency, a bandwidth, and an energy efficiency for a portion of the PON.
